(19) United States
(12) Patent Application Publication
(10) Pub. No.: US 2026/0081291 A1
(43) Pub. Date: Mar. 19, 2026

(54) BATTERY PACK

(71) Applicant: Prime Planet Energy & Solutions, Inc., Tokyo (JP)

(72) Inventor: Shinobu TERAUCHI, Kasai-shi (JP)

(21) Appl. No.: 19/322,681

(22) Filed: Sep. 9, 2025

(30) Foreign Application Priority Data
Sep. 17, 2024 (JP) 2024-159849

(51) Int. Cl. H01M 50/289; H01M 50/204; H01M 50/244; H01M 50/264; H01M 50/271

(52) U.S. Cl. CPC H01M 50/289; H01M 50/204; H01M 50/244; H01M 50/264; H01M 50/271

(57) ABSTRACT

In the present battery pack, a case includes: a cover body that covers an opening of a case main body; a partition plate that partitions a battery module disposed on the bottom portion side and a battery module disposed on the cover body side; a first support plate that is provided between the bottom portion and the partition plate on one end side of the partition plate in the first direction and that supports the one end of the partition plate; and a second support plate that is provided between the bottom portion and the partition plate on the other end side of the partition plate in the first direction and that supports the other end of the partition plate, one battery module is disposed between the partition plate and the bottom portion, and another battery module is disposed between the partition plate and the cover body.

### CROSS REFERENCE TO RELATED APPLICATIONS

This nonprovisional application is based on Japanese Patent Application No. 2024-159849 filed on Sep. 17, 2024 with the Japan Patent Office, the entire contents of which are hereby incorporated by reference.

### BACKGROUND OF THE INVENTION

### Field of the Invention

The present technology relates to a battery pack.

### Description of the Background Art

Japanese Patent Laying-Open No. 2013-114953 discloses a structure in which battery modules are arranged in two stages. By arranging the battery modules in the two stages, energy density of the battery pack can be improved and size reduction of the battery pack can be attained.

### SUMMARY OF THE INVENTION

In a battery pack, the number of battery cells included in a battery module to be mounted tends to be large. As a result, the weight of the battery module is also increased. On the other hand, when a large number of pillars are provided in a case in order to support the increased weight of the battery module, the case has a large size. As a result, this can be a factor that hinders the improved energy density and the size reduction of the battery pack.

The present technology has been made to solve the above problem and has an object to provide a battery pack including a configuration by which the size of a case can be suppressed from being large by effectively utilizing a space in the case.

The present technology provides the following battery pack.
[1] A battery pack comprising: a plurality of battery modules each including a plurality of battery cells arranged in a first direction; and a case that accommodates the plurality of battery modules, wherein the case includes a case main body having a bottom portion and a side wall portion surrounding a periphery of the bottom portion, a cover body that covers an opening of the case main body, a partition plate that is provided to extend in the first direction and that partitions a battery module disposed on the bottom portion side and a battery module disposed on the cover body side, a first support plate that is provided between the bottom portion and the partition plate on one end side of the partition plate in the first direction and that supports the one end of the partition plate, and a second support plate that is provided between the bottom portion and the partition plate on the other end side of the partition plate in the first direction and that supports the other end of the partition plate, one battery module is disposed between the partition plate and the bottom portion, and another battery module is disposed between the partition plate and the cover body.
[2] The battery pack according to [1], wherein each of the battery modules includes an end-portion plate disposed on the one end side and the other end side in the first direction so as to sandwich the battery cells, the battery module disposed between the partition plate and the bottom portion is fixed to the bottom portion by fixing the end-portion plate to the bottom portion, and the battery module disposed between the partition plate and the cover body is fixed to the partition plate by fixing the end-portion plate to the partition plate.
[3] The battery pack according to [2], wherein the end-portion plate has a first leg portion protruding to the bottom portion side, the battery module disposed between the partition plate and the bottom portion is fixed to the bottom portion such that the first leg portion of the end-portion plate is in abutment with the bottom portion, and the battery module disposed between the partition plate and the cover body is fixed to the partition plate such that the first leg portion of the end-portion plate is in abutment with the partition plate.
[4] The battery pack according to [2] or [3], wherein each of the battery modules includes an intermediate plate sandwiched between the battery cells at an intermediate position in the first direction, in the battery module disposed between the partition plate and the bottom portion, the intermediate plate is fixed to the bottom portion, and in the battery module disposed between the partition plate and the cover body, the intermediate plate is fixed to the partition plate.
[5] The battery pack according to [4], wherein the intermediate plate has a second leg portion protruding to the bottom portion side, the battery module disposed between the partition plate and the bottom portion is fixed to the bottom portion such that the second leg portion of the intermediate plate is in abutment with the bottom portion, and the battery module disposed between the partition plate and the cover body is fixed to the partition plate such that the second leg portion of the intermediate plate is in abutment with the partition plate.
[6] The battery pack according to [5], wherein the intermediate plate has a protuberance portion protruding to the cover body side, and the battery module disposed between the partition plate and the bottom portion is fixed to the partition plate such that the protuberance portion of the intermediate plate is in abutment with the partition plate.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing a configuration of a battery pack according to an embodiment.

FIG. 2 is an exploded perspective view of the battery pack according to the embodiment.

FIG. 3 is a cross sectional view along a line III-III in FIG. 1.

FIG. 4 is a cross sectional view along a line IV in FIG. 1.

### DESCRIPTION OF THE PREFERRED EMBODIMENTS

Hereinafter, embodiments of the present technology will be described. The same or corresponding portions are denoted by the same reference characters, and may not be described repeatedly.

In the embodiments described below, when reference is made to number, amount, and the like, the scope of the present technology is not necessarily limited to the number, amount, and the like unless otherwise stated particularly. In the embodiments described below, each component is not necessarily essential to the present technology unless otherwise stated particularly. The present technology is not limited to one that necessarily exhibits all the functions and effects stated in the present embodiment.

In the present specification, the terms “comprise”, “include”, and “have” are open-end terms. That is, when a certain configuration is included, a configuration other than the foregoing configuration may or may not be included.

In the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the term “battery” is not limited to a lithium ion battery, and may include other batteries such as a nickel-metal hydride battery and a sodium-ion battery. In the present specification, the term “electrode” may collectively represent a positive electrode and a negative electrode.

The “battery pack” in the present specification can be mounted on vehicles such as a hybrid electric vehicle (HEV), a plug-in hybrid electric vehicle (PHEV), and a battery electric vehicle (BEV). The use of the “battery pack” in the present specification is not limited to the use in a vehicle.

In the following description, a direction in which a plurality of battery cells are arranged in one battery module is defined as a first direction (X direction in the figures), a direction in which battery modules are arranged side by side in the same plane and which is orthogonal to the first direction (X direction in the figures) is defined as a second direction (Y direction in the figures), and a direction in which battery modules are arranged in two stages is defined as a third direction (Z direction in the figures). In order to facilitate understanding of the present technology, a dimensional ratio of each configuration in the figures may be illustrated to be changed from an actual dimensional ratio thereof.

### (Battery Pack 1)

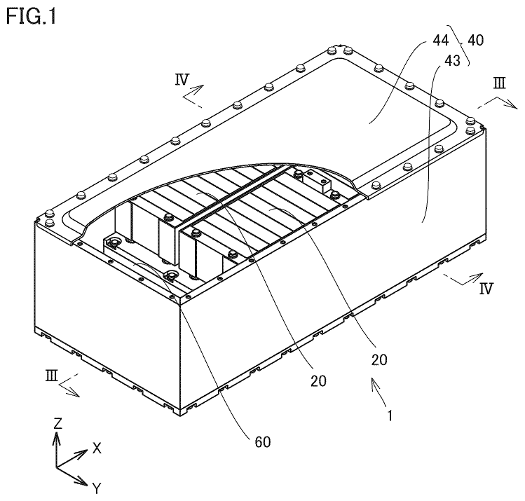

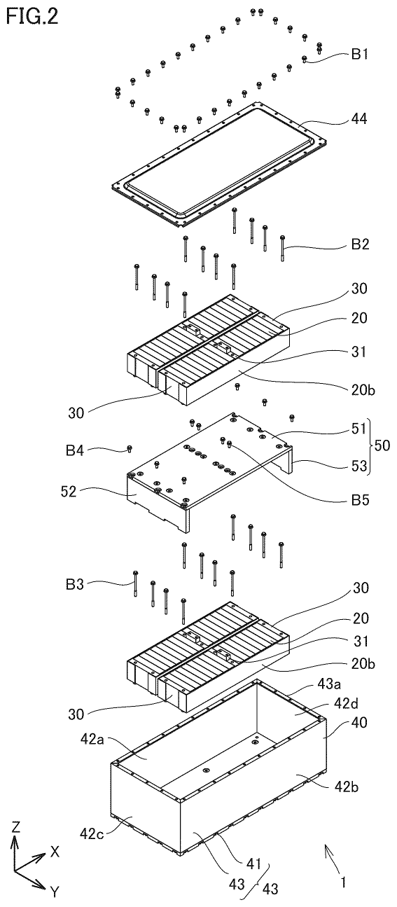

An overall configuration of battery pack 1 will be described with reference to FIGS. 1 and 2. Battery pack 1 includes: a plurality of battery modules 20 each including a plurality of battery cells 2 arranged in the first direction (X direction); and a case 40 that accommodates the plurality of battery modules 20. Each of battery cells 2 has a prismatic external shape. Each of battery modules 20 includes end-portion plates 30 disposed on one end side and the other end side in the first direction (X direction) so as to sandwich battery cells 2. Battery module 20 includes an intermediate plate 31 sandwiched between battery cells 2 at an intermediate position in the first direction (X direction). By fastening end-portion plates 30 on the both sides by a binding bar 20b or the like, battery module 20 is fixed to be integrated.

In battery pack 1 of the present embodiment, case 40 is provided with a region 60 in which a device or the like is to be disposed, but whether to provide region 60 is appropriately selected depending on performance required for battery pack 1.

### (Forms of End-Portion Plate 30 and Intermediate Plate 31)

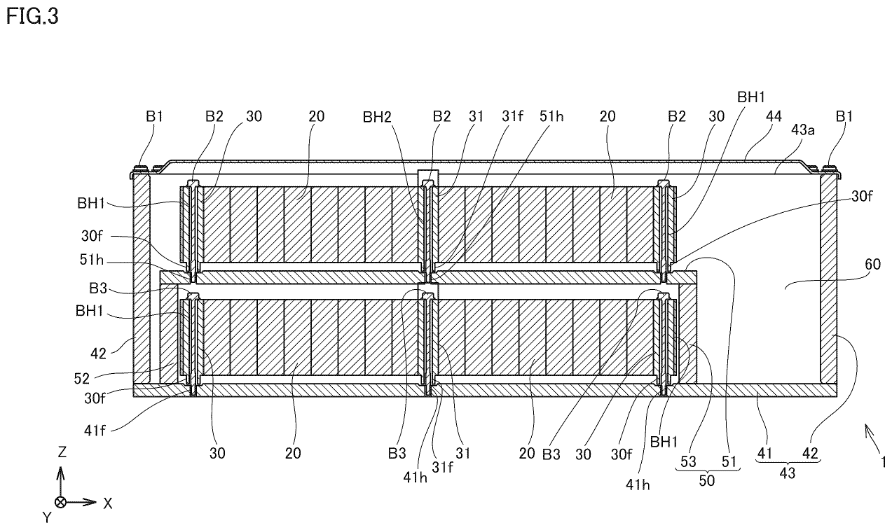

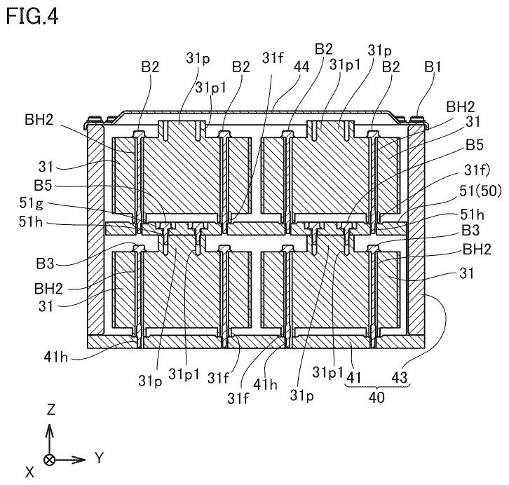

Forms of each end-portion plate 30 and intermediate plate 31 will be described with reference to FIGS. 3 and 4. End-portion plate 30 is constituted of a member composed of a resin, a metal, or the like. End-portion plate 30 has first leg portions 30f each protruding to the bottom portion 41 side. In the present embodiment, first leg portions 30f are provided at two locations with a predetermined clearance being interposed therebetween in the second direction (Y direction) (in a manner similar to second leg portions 31f of intermediate plate 31 as described later). Further, through holes BH1 each extending through end-portion plate 30 in the third direction (Z direction) are provided so as to include first leg portions 30f.

Intermediate plate 31 is constituted of a member composed of a resin, a metal, or the like. Intermediate plate 31 has second leg portions 31f each protruding to the bottom portion 41 side. In the present embodiment, second leg portions 31f are provided at two locations with a predetermined clearance being interposed therebetween in the second direction (Y direction). Further, through holes BH2 each extending through intermediate plate 31 in the third direction (Z direction) are provided so as to include second leg portions 31f.

Intermediate plate 31 has a protuberance portion 31p protruding to the cover body 44 side. Protuberance portion 31p is provided at a position between through holes BH2 provided at the two locations. Screw holes 31p1 each extending to the bottom portion 41 side in the third direction (Y direction) are provided in protuberance portion 31p at two locations along the second direction (Y direction).

### (Fixation of Battery Modules 20)

In the present embodiment, battery modules 20 are arranged in two rows in the second direction (Y direction) and battery modules 20 are stacked in two stages in the third direction (Z direction) in case 40, with the result that four battery modules 20 are accommodated in case 40 in total. Regarding the number of battery modules 20 accommodated in case 40, the number of battery modules 20 arranged in the second direction (Y direction) may be one or more as long as battery modules 20 are configured to be stacked in two stages in the third direction (Z direction).

Referring to FIG. 2 again, battery modules 20 arranged in two rows, a support member 50, and battery modules 20 arranged in two rows are accommodated in case 40 in this order from the lower side to the upper side as shown in the figure, and an opening 43a of the upper portion of case 40 is closed by cover body 44. Cover body 44 is fixed to case 40 using bolts B1.

Support member 50 includes: a partition plate 51 that is provided to extend in the first direction (X direction) and that partitions battery modules 20 disposed on the bottom portion 41 side and battery modules 20 disposed on the cover body 44 side; a first support plate 52 that is provided between bottom portion 41 and partition plate 51 on one end side of partition plate 51 in the first direction (X direction) and that supports the one end of partition plate 51; and a second support plate 53 that is provided between bottom portion 41 and partition plate 51 on the other end side of partition plate 51 in the first direction (X direction) and that supports the other end of partition plate 51.

With this support member 50, battery modules 20 are disposed between partition plate 51 and bottom portion 41, and battery modules 20 are disposed between partition plate 51 and cover body 44.

### (Battery Modules 20 on Cover Body Side)

Referring to FIGS. 3 and 4 again, each battery module 20 disposed between partition plate 51 and cover body 44 is fixed to partition plate 51 by fixing end-portion plates 30 and intermediate plate 31 to partition plate 51. Specifically, each of end-portion plates 30 has first leg portions 30f each protruding to the partition plate 51 (bottom portion 41) side. Battery module 20 is fixed to partition plate 51 such that first leg portions 30f are in abutment with partition plate 51.

Similarly, intermediate plate 31 has second leg portions 31f each protruding to the partition plate 51 (bottom portion 41) side. Battery module 20 is fixed to partition plate 51 such that second leg portions 31f are in abutment with partition plate 51.

More specifically, end-portion plate 30 is fastened and fixed to bolt holes 51h provided in partition plate 51 in such a manner that bolts B2 extend through through holes BH1 provided to extend through end-portion plate 30 in the third direction (Z direction) so as to include first leg portions 30f. The fastening by bolts B2 using first leg portions 30f is provided at two locations in end-portion plate 30 on the one end side and is provided at two locations in end-portion plate 30 on the other end side.

Intermediate plate 31 is fastened and fixed to bolt holes 51h provided in partition plate 51 in such a manner that bolts B2 extend through through holes BH2 provided to extend through intermediate plate 31 in the third direction (Z direction) so as to include second leg portions 31f. The fastening by bolts B2 using second leg portions 31f is provided at two locations.

### (Battery Modules 20 on Bottom Portion Side)

Each of battery modules 20 disposed between partition plate 51 and bottom portion 41 is fixed to bottom portion 41 by fixing end-portion plates 30 and intermediate plate 31 to bottom portion 41. Specifically, each of end-portion plates 30 has first leg portions 30f each protruding to the bottom portion 41 side as described above. Battery module 20 is fixed to bottom portion 41 such that first leg portions 30f are in abutment with bottom portion 41.

Similarly, intermediate plate 31 has second leg portions 31f each protruding to the bottom portion 41 side. Battery module 20 is fixed to partition plate 51 such that second leg portions 31f are in abutment with bottom portion 41.

More specifically, end-portion plate 30 is fastened and fixed to bolt holes 41h provided in bottom portion 41 in such a manner that bolts B2 extend through through holes BH1 provided to extend through end-portion plate 30 in the third direction (Z direction) so as to include first leg portions 30f. The fastening by bolts B2 using first leg portions 30f is provided at two locations in end-portion plate 30 on the one end side and is provided at two locations in end-portion plate 30 on the other end side.

Intermediate plate 31 is fastened and fixed to bolt holes 41h provided in bottom portion 41 in such a manner that bolts B2 extend through through holes BH2 provided to extend through intermediate plate 31 in the third direction (Z direction) so as to include second leg portions 31f. The fastening by bolts B2 using second leg portions 31f is provided at two locations.

Further, intermediate plate 31 is provided with protuberance portion 31p protruding to the partition plate 51 (cover body 44) side. Via screw holes 31p1 provided in protuberance portion 31p, bolts B5 extend through partition-plate through holes 51g provided in partition plate 51, thereby fixing protuberance portion 31p to partition plate 51. The fastening by bolts B5 using protuberance portion 31p is provided at two locations. When providing each partition-plate through hole 51g in partition plate 51, a bolt head groove 51f may be provided in order to avoid the head of bolt B5 from being exposed from partition plate 51.

By fixing intermediate plate 31 to partition plate 51, intermediate plate 31 serves as a support pillar that supports the partition plate, thereby suppressing occurrence of flection and vibration of partition plate 51.

According to battery pack 1 described above, by using support member 50, the space in case 40 can be effectively utilized, thereby suppressing increased size of case 40.

Further, by employing the above-described fixing structure for battery modules 20, a clearance is provided between each battery module 20 disposed on the bottom portion side and bottom portion 41, and a cooling member can be disposed in the clearance, for example. Similarly, a clearance is provided between each battery module 20 disposed on the cover portion side and partition plate 51, and a cooling member can be disposed in the clearance, for example.

In the above-described configuration, there has been illustratively shown the configuration in which battery modules 20 are arranged in two rows in the second direction (Y direction) and battery modules 20 are stacked in two stages in the third direction (Z direction); however, also in a configuration in which one battery module 20 is arranged in the second direction (Y direction) or battery modules 20 are arranged in three or more rows in the second direction (Y direction) and battery modules 20 are stacked in three stages in the third direction (Z direction), it is possible to obtain the same functions and effects as those in the present embodiment.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A battery pack comprising:
a plurality of battery modules each including a plurality of battery cells arranged in a first direction; and
a case that accommodates the plurality of battery modules, wherein the case includes
a case main body having a bottom portion and a side wall portion surrounding a periphery of the bottom portion,
a cover body that covers an opening of the case main body,
a partition plate that is provided to extend in the first direction and that partitions a battery module disposed on the bottom portion side and a battery module disposed on the cover body side,
a first support plate that is provided between the bottom portion and the partition plate on one end side of the partition plate in the first direction and that supports the one end of the partition plate, and
a second support plate that is provided between the bottom portion and the partition plate on the other end side of the partition plate in the first direction and that supports the other end of the partition plate,
one battery module is disposed between the partition plate and the bottom portion, and
another battery module is disposed between the partition plate and the cover body.

2. The battery pack according to claim 1, wherein
each of the battery modules includes an end-portion plate disposed on the one end side and the other end side in the first direction so as to sandwich the battery cells,
the battery module disposed between the partition plate and the bottom portion is fixed to the bottom portion by fixing the end-portion plate to the bottom portion, and
the battery module disposed between the partition plate and the cover body is fixed to the partition plate by fixing the end-portion plate to the partition plate.

3. The battery pack according to claim 2, wherein
the end-portion plate has a first leg portion protruding to the bottom portion side,
the battery module disposed between the partition plate and the bottom portion is fixed to the bottom portion such that the first leg portion of the end-portion plate is in abutment with the bottom portion, and
the battery module disposed between the partition plate and the cover body is fixed to the partition plate such that the first leg portion of the end-portion plate is in abutment with the partition plate.

4. The battery pack according to claim 2, wherein
each of the battery modules includes an intermediate plate sandwiched between the battery cells at an intermediate position in the first direction,
in the battery module disposed between the partition plate and the bottom portion, the intermediate plate is fixed to the bottom portion, and
in the battery module disposed between the partition plate and the cover body, the intermediate plate is fixed to the partition plate.

5. The battery pack according to claim 4, wherein
the intermediate plate has a second leg portion protruding to the bottom portion side,
the battery module disposed between the partition plate and the bottom portion is fixed to the bottom portion such that the second leg portion of the intermediate plate is in abutment with the bottom portion, and
the battery module disposed between the partition plate and the cover body is fixed to the partition plate such that the second leg portion of the intermediate plate is in abutment with the partition plate.

6. The battery pack according to claim 5, wherein
the intermediate plate has a protuberance portion protruding to the cover body side, and
the battery module disposed between the partition plate and the bottom portion is fixed to the partition plate such that the protuberance portion of the intermediate plate is in abutment with the partition plate.
